(19) United States
(12) Patent Application Publication
(10) Pub. No.: US 2010/0098256 A1
(43) Pub. Date: Apr. 22, 2010

(54) Decryption Key Management

(76) Inventor: Evan R. KIRSHENBAUM, Mountain View, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/256,347

(22) Filed: Oct. 22, 2008

(51) Int. Cl. H04L 9/06

(52) U.S. Cl. 380/277

(57) ABSTRACT

Provided are, among other things, systems, methods and techniques for decryption key management. In one implementation, a decryption key is managed within a computer processing system by (a) creating within the computer system an association between an access token and retrieval information, the access token being a specified function of an identifier for a data object, and the retrieval information including (1) a first entry that corresponds to a value generated by encrypting a decryption key for the data object using a symmetric encryption/decryption key, and (2) a second entry that corresponds to a value generated by encrypting the symmetric encryption/decryption key using an asymmetric public key; and (b) repeating step (a) for a number of different data objects, keeping the symmetric encryption/decryption key identical across repetitions.

### FIELD OF THE INVENTION

The present invention pertains to management of decryption keys and is applicable, e.g., to key management for an encrypted data store.

### BACKGROUND

There are many conventional decryption-key-distribution schemes. Such schemes tend to fall into a few general categories.

In out-of-band distribution schemes, the entity being granted access (the grantee) is given the decryption key directly by the entity granting the access (the grantor). The key often is embedded in another communication and either sent in the clear or encrypted by a symmetric (shared secret) key or by an asymmetric (public) key. The disadvantages of such methods are manifold. First, they typically require that for every access grant, the grantor must communicate with the grantee. If access is granted on the level of individual files, there may be many millions of such grants. Second, these approaches typically require that there be a communication path between the grantor and grantee. Third, the grantee typically is obligated to store and keep track of all the decryption keys. Fourth, when using such methods the grantee explicitly is made aware of the existence of various encrypted files and that he or she has been granted access to them, rather than providing access only on a need-to-know basis.

In an access-control distribution scheme, the store containing the file is trusted with the decryption keys and is given lists of identities that are allowed to get such keys. When a client attempts to retrieve a decryption key, the store checks to see that the client has proven that it has one of the identities on the corresponding list; if so, the decryption key is given to it, again either in the clear or encrypted by a symmetric or asymmetric key. The main disadvantage of these schemes is that the store has to be trusted to play its part and not leak information to other parties. If the store is compromised, so is all of the information it contains, including the information regarding who has been granted access to what.

In a variant of the access-control scheme, which might be called a metadata-based scheme, the grantor does not trust the store with the key itself, but annotates the file with encryptions of the decryption key. When a client requests a decryption key for a file, it provides an identity, and the store replies with the stored encrypted decryption key, which the client then decrypts. This approach can eliminate the problem of trusting the store not to leak the content, but it still trusts the store not to leak the identities that have been granted access. Further, such schemes have to deal with distributing the keys used to decrypt the decryption keys. If symmetric keys are used, there is the normal worry about their relative weakness (especially given that these keys are likely to be long-lived) and the problem of distributing them securely. If public keys are used (as is typical), an expensive public key decryption is required in order to get access to each file. Also, it is possible for a malicious party to replace the encrypted decryption key (or pre-seed it) with a bogus one in a way that will be undetectable by others, rendering the grantee unable to decrypt the file and fraudulently convincing others that access has already been granted, so they need not do so.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram illustrating a computer system within which certain embodiments of the present invention are implemented;

FIG. 2 illustrates a portion of a HDAG data structure;

FIG. 3 is a flow diagram of a technique for storing decryption keys;

FIG. 4 is a conceptual block diagram showing a single data storage node and an index of pointers to data storage nodes;

FIG. 5 is a flow diagram illustrating a process for retrieving a stored decryption key;

FIG. 6 is a conceptual block diagram illustrating retrieval of a pair of values in connection with a decryption key retrieval; and

FIG. 7 is a block diagram illustrating a technique for selecting an access parent from a set of available access pairs using previously stored trust information.

### DESCRIPTION OF THE PREFERRED EMBODIMENT(S)

The present invention is in some respects an extension of the disclosures provided in U.S. patent application Ser. No. 11/149,509, filed Jun. 10, 2005, titled “Identifying Characteristics in Sets of Organized Items” and published as U.S. Patent Application Publication No. 20060282475 on Dec. 14, 2006, Ser. No. 11/514,634, filed Sep. 1, 2006, and titled, “Data Structure Representation Using Hash-Based Directed Acyclic Graphs and Related Method” (the '634 application), and Ser. No. 11/888,092, filed Jul. 31, 2007, and titled, “Storing Nodes Representing Respective Chunks of Files in a Data Store” (the '092 application), which applications are incorporated by reference herein as though set forth herein in full. The present invention also is related to the concurrently filed, commonly assigned patent applications by the present inventor titled “Access Grants” (the “Access Grants” application) and “Managing Associations between Keys and Values” (the “Associations” application), which applications also are incorporated by reference herein as though set forth herein in full.

The present invention addresses, among other things, the problem of how to distribute decryption keys. For example, the techniques of the present invention can be used as an alternate approach to distributing decryption keys within a context in which an encrypted hash-based directed acyclic graph (HDAG) is used, as described in the '634 application and the '092 application.

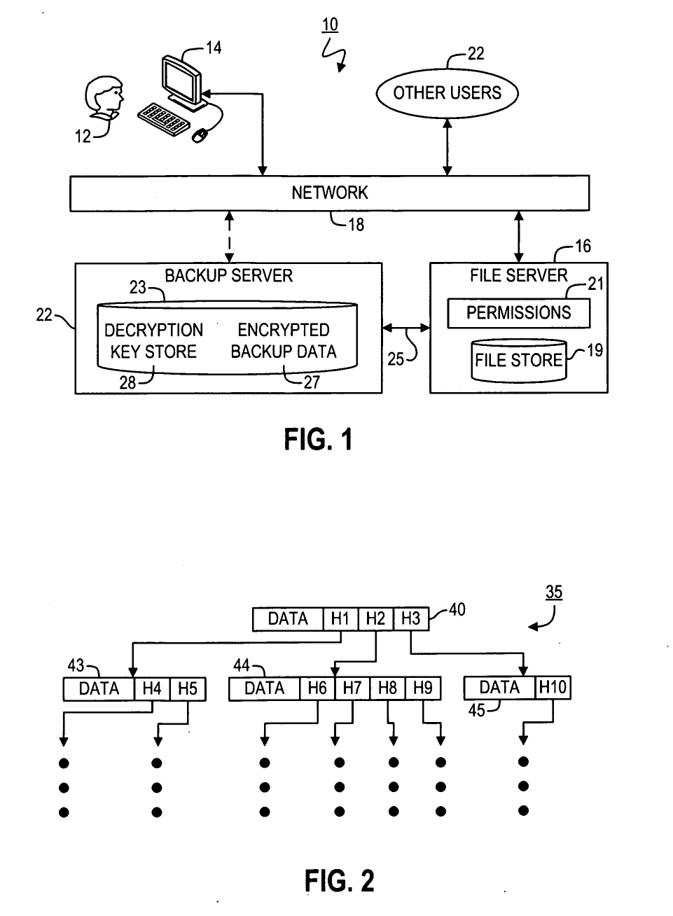

An example of one context in which certain aspects of the present invention may be utilized is system 10, illustrated in FIG. 1. As shown in system 10, a user 12 operating through a computer 14 accesses data in a file server 16 via network 18. At the same time, a number of other users 22 (e.g., tens, hundreds or thousands of other users) also are able to access file server 16 via network 18. Within file server 16 is a file store 19 which typically includes a number of data files arranged in a hierarchical data structure. Such files are accessible through file server 16, subject to user-defined permissions 21 that specify who has access to what files, folders, directories, etc. It is noted that although server 16 is shown as a single component, it often in fact is comprised of multiple server boxes (e.g., collectively functioning as a single logical unit).

Also provided in system 10 is a backup server 22 (which also can include multiple server boxes collectively functioning as a single logical unit) that backs up the file system data contained in the file store 19. In certain embodiments of the invention, such backups are performed periodically (e.g., weekly, nightly or hourly); in other embodiments, such backups are performed on a continuous basis (e.g., automatically creating an archive copy of prior versions of files as they change or as the new versions are saved by the user 12); in still further embodiments, such backups are performed when and/or to the extent manually designated by user 12 (e.g., when a new version of a software product is released, the user 12 might designate that all of the source code and other files related to it are to be archived); in still further embodiments, such backups are performed using any combination of the foregoing approaches.

For such purposes, backup server 22 includes (or has access to) at least one storage medium 23, which in certain embodiments of the invention is removable from backup server 22. In the various embodiments, the backup communications 25 between file server 16 and backup server 22 are via a direct connection, via network 18, via another network (e.g., the Internet) and/or via any other communications link. In order to provide greater protection against a widespread disaster, it sometimes is desirable to locate backup server 22 and/or storage medium 23 in a remote facility (e.g., in a different region of the country).

In alternate embodiments of the invention, file store 19 and/or backup server 22 (e.g., implemented as a backup utility) are located on local device 14, rather than being accessed from a separate server 16 or 22, respectively, across network 18. For example, it can be beneficial to include such an encrypted archive on computer 14 if there is more than one person who has access to computer 14 and/or if others are provided remote access to computer 14.

Preferably, backup server 22 stores the backed-up data 27 in a hierarchical arrangement that generally matches the hierarchical arrangement of the data objects in file store 19. At the same time, however, in order to save storage space and data transmission bandwidth, the backed-up data 27 preferably are stored in such a way that when it is determined that content to be stored already is present on backup server 22, only a single copy is stored (or, for redundancy purposes, a specified number of copies are stored) and a new copy need not be transferred. One preferable way of-achieving this goal is to store the backed-up data 27 within a data structure formatted as a hash-based directed acyclic graph (HDAG) that mirrors the hierarchical arrangement of data objects in file store 19, e.g., as described in the '634 application and/or the '092 application. In this regard, it is noted that backup server 22 often will make multiple backups at different points in time, with each backup essentially being a snapshot of the contents of file store 19 any given point in time. Also, multiple file stores 19 might back up data using backup server 22 and their file stores 19 might contain some of the same content. The use of a HDAG data structure as described in the '634 application and/or the '092 application often provides significant efficiencies by eliminating repeated storage of the same data.

An example of such a HDAG data structure 35 is shown in FIG. 2. In this example, all of the backed-up data 27 are represented by a root node 40 (e.g., corresponding to a drive that includes the entire contents of the file store 19). Root node 40, in turn, has a number of child nodes, such as child nodes 43-45 (e.g., corresponding to different directories within the main drive). Included within root node 40 is certain data (typically, just metadata at this level) and a separate hash of the contents of each of its child nodes (e.g., hashes H1-H3 of nodes 43-45, respectively), with each hash also functioning as a pointer to the corresponding child node.

Each such child node 43-45, in turn, includes a number of its own children (e.g., corresponding to folders and/or files within those directories), again with each such child represented within the subject node (e.g., one of nodes 43-45) by a hash of the child node's contents, with such hash also functioning as a pointer to the child node. In practice, the hierarchical data structure can be large and include many levels, with individual folders containing subfolders and with documents, files or other data objects being included within any or all of such drives, directories, folders and subfolders. Typically, only the data fields in the leaf nodes contain actual content other than metadata. In certain embodiments of the invention, the HDAG data structure 35 extends down below the level of file, splitting up large files into multiple chunks, so that at least some of the leaf nodes correspond to data chunks that are just portions of a file.

In any event, in accordance with the general HDAG structure, higher-level nodes include one or more hashes, generated from content within their child nodes. Typically, each such hash is calculated across all of the content of the corresponding child node. However, in certain embodiments, the hash is only calculated across content within the corresponding child node that is deemed as relevant (e.g., content that one wishes to monitor).

As a result of this structure, and assuming that each parent includes a hash for each child (or at least each relevant child) the backup server is able to determine whether an entire sub-structure of the hierarchy corresponding to the hash of its topmost node already has been stored (or, more generally, is otherwise present) and, if so, to simply include a pointer to the previously stored node. On the other hand, if the entire sub-structure is not present, the topmost node is sent and the system preferably drills down deeper into the hierarchy to check for matches at lower levels. The end result is that preferably only the smallest data units monitored that actually have been modified since the last backup (along with a “spine” of nodes above them) are copied over in the current backup. As noted above, this data storage approach is described in more detail in the '634 application and in the '092 application. It is further noted that, although described above in the context of a data-backup operation, HDAG structures can in fact be used in a wide variety of situations where comparisons between sets of data objects are desirable.

As also noted above, in the present embodiment, associated with the data stored in file store 19 is a corresponding set of permissions 21 indicating who has rights to view and/or edit various aspects of the data and data structure. In order to enforce those permissions in the backup copy of the data 27, such data 27 (or at least any restricted file within data 27) preferably is encrypted, with the encryption key for a particular directory, folder, file or other data object being made available only to those entities that have been given permission to access it. Accordingly, storage medium 23 preferably also includes a decryption key store 28 to manage the storage and retrieval of the decryption keys. In the preferred embodiments, the data in decryption key store 28 are stored in the same or similar data structures that are use to store the actual backup data 27.

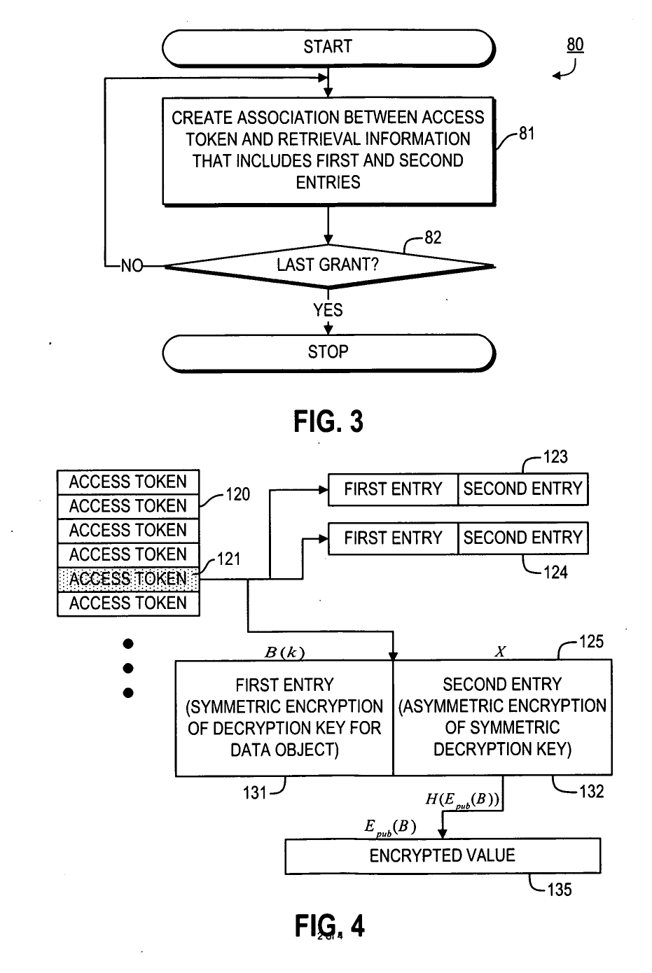

A description of a process 80 for storing decryption keys into store 28 and making them available to one or more intended grantees according to certain representative embodiments of the invention is now described with primary reference to FIG. 3. Preferably, the steps of the process 80 are performed in a fully automated manner so that the entire process 80 can be performed by executing computer-executable process steps from a computer-readable medium (which can include such process steps divided across multiple computer-readable media), or in any of the other ways described herein.

Initially, in step 81 an association is created within a computer system (e.g., decryption key store 28) between an access token, on the one hand, and retrieval information that includes first and second entries, on the other. Ordinarily, step 81 is executed any time a decryption key (generally represented by k herein) is to be made available to an entity (ordinarily referred to herein as the grantee) for a particular data object (e.g., directory, folder or file). As noted above, this situation typically arises any time that a grantee is to be given permission to access the data object (e.g., to match one of the permissions 21). It is further noted that, as used herein, the term “entity” refers to any individual natural person, group of people, organization or even software or other automated agent, and may refer to such people, groups, organizations, software or-automated agents as defined by the temporary or permanent assumption of a particular role, job, or title, by the temporary or permanent possession of a grant, capability, password, secret, or other token, or by a demonstrated ability, such as the ability to provide an appropriate response to a challenge. Also, in the preferred embodiments k is a symmetric encryption/decryption key that has been used to encrypt the subject data object and is different for each different data object; more preferably, partly for the purpose of verification, as described in more detail below, k is a hash of the unencrypted contents of the data object that it is used to encrypt.

The present disclosure frequently refers to associations between data values within decryption key store 28 (which, in turn, preferably is implemented within a computer system). Generally speaking, this terminology means that when a designated one of the values (generally referred to herein as the access token) is presented to the store 28 in a manner that indicates a request to retrieve associated values, all (in some embodiments, all relevant or all authorized) such associated values are returned. Such associations can be visualized graphically as a node containing the access token and one or more directed edges to corresponding node(s) containing the associated value(s), with each such node containing one or more of such associated value(s). Although any known techniques can be used to create such associations, the techniques described in the “Associations” application presently are preferred.

One approach to implementing such associations involves generating tables or indexes that list access tokens and, for each, all of the values that are associated with it. Such an approach often permits very fast retrieval at the cost of a significant amount of processing to set up the tables or indexes in the first instance. Alternatively, for example, the associations can be stored in a less structured manner, such as by simply storing the access token and associated values in a single chunk. Such alternate approaches typically require less setup processing but additional retrieval processing (usually involving searching) when associated values are to be retrieved. In one particular example, the same structure is used to retrieve nodes containing associated values as is used to retrieve data nodes from the encrypted backup data store 27. In any event, where specific examples of associations are referenced herein (e.g., using a pointer to a data storage location or node), it should be understood that such references are exemplary only and any other kind of association instead could be used.

Thus, the association created in step 81 preferably allows an entity to access retrieval information by submitting an access token. In the preferred embodiments of the invention, the value of the access token is a specified function of an identifier for the subject data object and also is a function of a credential or other identifier associated with the grantee.

More preferably, the specified function is a hash of a concatenation, other combination, or other function of the identifier for the subject data object and the credential associated with the grantee, e.g., H(h;Id), where H(×) designates a cryptographic hash function (e.g., MD5 or SHA-1); h is a hash of the content the data object or, less preferably, some other unique identifier for the data object (such as a file path and name); Id is a credential or other identifier (such as a user name or employee number) associated with the grantee; and the notation x;y refers to the concatenation or other preferably unique combination of the values x and y. In some embodiments, this combination involves other information, such as a secret shared between grantor and grantee (or among members of an organization to which both grantor and grantee belong) or, in cases in which different decryption keys are required to decrypt different parts of an encrypted data object, an indication of which decryption key is desired. The term “cryptographic hash function”, as used herein, has its normal meaning in the art, i.e., a hash function that is prohibitively difficult to invert and that has the property that it is highly unlikely that any two distinct values will hash to the same value. The term “hash function”, as used herein, also has its normal meaning in art, i.e., a function that takes an arbitrary input and outputs a fixed-length data string. It should be noted that although the same letter, namely “H”, is used for all cryptographic hash functions, unless required for comparison, different uses of cryptographic hashes may use different cryptographic hash algorithms and/or parameterizations.

As conceptually illustrated in FIG. 4, decryption key store 28 preferably includes a set 120 of access tokens, with each access token (e.g., access token 121) having associated with it one or more sets of retrieval information (e.g., retrieval information sets 123-125). FIG. 4 is merely conceptual because, as noted above, the actual manner storage often will vary among the different embodiments. In the preferred embodiments, each access token is uniquely defined by the identity of the grantee and the data object to which the desired decryption key k pertains (together with any other information). Accordingly, such multiple retrieval information sets 123-125 might exist, e.g., because different grantors have granted access to the same data object to the same grantee, because a single grantor has (either-intentionally or inadvertently) given a grantee access to the same data object multiple times, or for a number of other reasons, including where a malicious party has attempted to seed decryption key store 28 with bogus information.

In the present embodiment, each retrieval information set (e.g., set 125) includes two entries and therefore sometimes is referred to herein as a data access pair. Such entries preferably include: (1) a first entry 131 corresponding to a value that has been generated by encrypting the symmetric encryption/decryption key (k ) for the subject data object using a symmetric encryption/decryption key (typically represented by B herein); and (2) a second entry 132 corresponding to a value that has been generated by encrypting the symmetric encryption/decryption key (B) using an asymmetric public key for which the grantee has a corresponding private key. It should be noted that in the various embodiments of the present invention, a retrieval information set can include any number of entries. Accordingly, where the term “data access pair” is used herein, each such reference should be understood as just one example of a retrieval information set.

Ordinarily, B can be any arbitrary (e.g., a randomly or pseudo-randomly generated) value; in any event, in the preferred embodiments, B is generated once and then used across multiple grants to the same grantee (e.g., all grants made to that grantee by a single grantor or all grants made to that grantee by a single grantor in a single session, such as a single backup session). The phrase “corresponding to a value” is intended to cover embodiments in which the value is included as well as embodiments in which it is possible, based on information included, to retrieve the value from a location outside the retrieval information set. In either case, the actual value included or retrieved may have been subject to transformations. Note that in some embodiments the method of correspondence for the first entry 131 may differ from the method of correspondence for the second entry 132.

More specifically, in the simplest embodiment, the first entry 131 is just B(k), although in alternate embodiments it is any other value obtained by encrypting k, either alone or in combination with any other data. Similarly, in the simplest embodiments, the second entry 132 is just X=E_{pub}(B), where E_{pub}(×) is an encryption using the grantee's public key or X=H(E_{pub}(B)). Generally speaking, in the former case, E_{pub}(B) is directly embedded in the data storage node 125 as the second entry, while in the latter case the second entry is associated with (e.g., functions as a secondary access token for a data storage node, within a content-addressable store which might or might not be the same as the decryption key store 28, that includes) E_{pub}(B). Preferably, such associated value (e.g., E_{pub}(B)) is stored at the time of the grant, unless such a data storage node is known to already exist in the data store. FIG. 4 illustrates the case in which the first entry 131 is B(k) and the second entry 132 is associated with a node 135 that includes the actual encrypted value, i.e., E_{pub}(B) in this example. That is, the second entry 132 functions as a secondary access token. Of course, it should be noted that the value H(E_{pub}(B)) is just exemplary, and any other value for such a secondary access token instead can be used. It should also be noted that access using the secondary access token can be by means of a different mechanism from access by the access token and that either or both might be used to retrieve values from a content-addressable store, an associative store, a database, a file system, a server, a query system, an in-memory data structure, or any other system capable of returning values, whether on the same physical system, an attached physical system, or a remote physical system.

In step 82, a determination is made as to whether the last grant has been made. This criterion can mean, e.g., the last grant to the particular grantee by a particular grantor or the last grant to the particular grantee by the particular grantor in a given session. In any case, if the criterion is satisfied, then processing is complete and the entire process 80 is only repeated when a new group of grants is to be made, e.g., to a different grantee using a different value of B. On the other hand, if additional grants are to be made, then processing returns to step 81 in order to repeat the process, preferably with the grants made across all repetitions being to the same grantee using the same value of B and with different values of B being used for grants to different grantees.

As discussed in more detail below, in certain embodiments of the invention, it is desirable to store grants for the same data object made to different grantees in the same data storage node. In such embodiments, rather than creating a new data storage node, if one already exists for a particular data object (e.g., because rights have been granted to another grantee), then in step 81 it is only necessary to create a new pointer to that existing data storage node 125 and then supplement the data values within that node 125 in step 82. As a result, in such embodiments a single data storage node 125 can include multiple values for X, corresponding to grants made to different grantees.

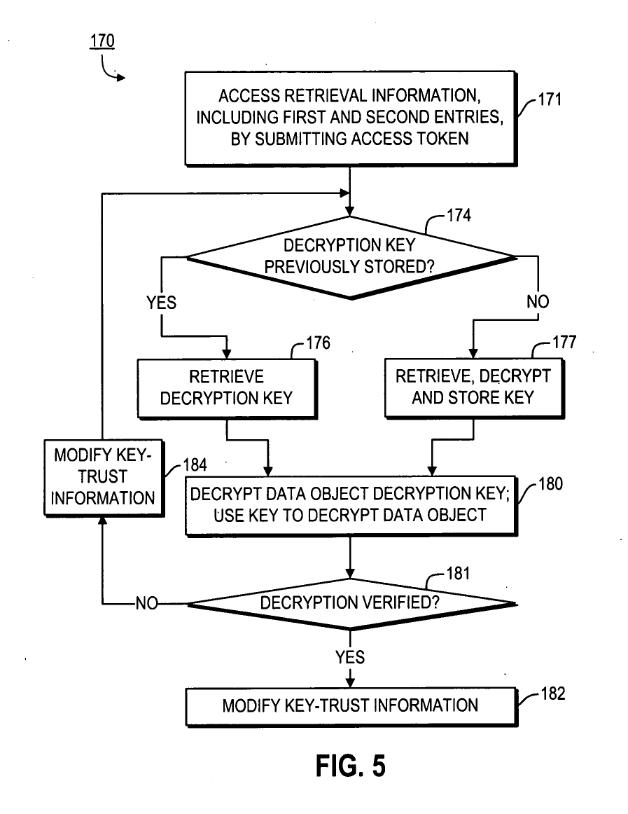

FIG. 5 illustrates a process 170 that is used in certain representative embodiments of the invention for retrieving a decryption key. In one exemplary embodiment, process 170 is used to retrieve or otherwise obtain a decryption key for an encrypted data object which is desired to be retrieved or which recently has been retrieved, e.g., when restoring encrypted backup data. Preferably, the steps of the process 170 are performed in a fully automated manner so that the entire process 170 can be performed by executing computer-executable process steps from a computer-readable medium, or in any of the other ways described herein.

Typically, process 170 will be initiated by an entity in order to retrieve and access a particular encrypted stored data object. For instance, in the example given above, a user 12 might request (e.g., through a backup program) to retrieve a backed-up a copy of a file (e.g., because the system file within store 19 has become corrupted, was accidentally deleted, or has been modified and the user 12 wishes to retrieve the previous version). In response to such a request, the process 170 preferably is automatically executed, e.g., through software executed on user device 14, backup server 22, or any combination of the two.

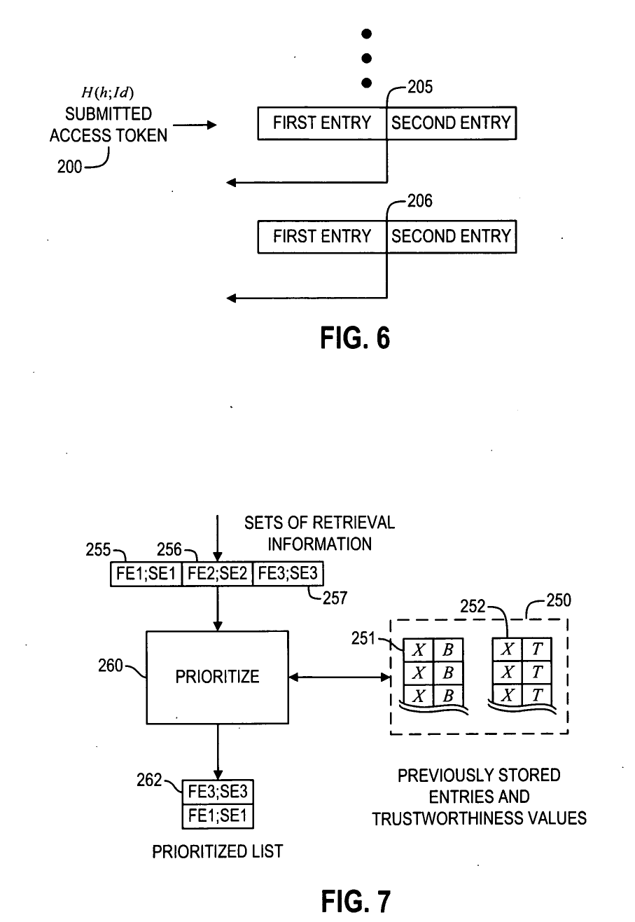

Initially, in step 171 retrieval information is accessed by submitting an access token (e.g., to decryption key store 28). Preferably, the access token is derived from (e.g., includes or, preferably, is computed as a mathematical function applied to parameters including) a data object identifier and a credential associated with the entity, and the retrieval information includes one or more retrieval information sets, each including first and second entries. In one example, the user 12 accesses backup server 22 and, e.g., as shown in FIG. 6, submits an access token 200 that has been generated in the same manner as discussed above in connection with step 81. As noted above, the access token 200 in one embodiment of the invention is H(h;Id).

In the example shown in FIG. 6, the retrieval information returned by decryption key store 28 includes retrieval information sets 205 and 206, each including first and second entries. As shown, in certain cases there will be multiple sets of retrieval information associated with a single access token 200. In the preferred embodiments, if multiple sets of retrieval information in fact exist, a prioritization technique is executed and/or one of such sets is selected for further processing. Generally speaking, such a situation means that the retrieval information includes a plurality of access grant indications (i.e., each retrieval information set being a different access grant indication), and so a step of selecting one of the grant indications preferably is performed based on historical information regarding trustworthiness An example of such a technique is illustrated in FIG. 7.

In the present embodiment, one or more tables of information 250 that have been populated based on previous decryption key retrievals are maintained by the entity attempting to access the current data object. Preferably, for embodiments where it is deemed likely that there exists only a single encryption/decryption code (B) associated with any given value for X, the tables 250 include one table 251 mapping X to the corresponding symmetric encryption/decryption code (B) and another table 252 mapping X to a measure of the trustworthiness (T ) for such X value. In alternate embodiments, a single table is used (e.g., by combining tables 251 in 252 into a single table).

The multiple returned sets of retrieval information (e.g., data access pairs 255-257) are input into the prioritization routine 260, which sorts the data access pairs by the trustworthiness (T) values associated with the second entries SE1-SE3 for the respective data access pairs 255-257 in table 252, e.g., using a specified default trustworthiness value for second entries which do not correspond to a row in table 252 (or which, in a combined table, correspond to rows which do not indicate a trustworthiness value T) and returns a subset of the list corresponding to those pairs whose second entry has an associated trustworthiness value T that exceeds a specified threshold, the threshold preferably being- less than the default trustworthiness value, with each returned pair preferably annotated with the corresponding value for B, taken from table 251, if such a corresponding value is exists. In some embodiments it may be desirable to modify the sorting rules to have some relatively less trusted pairs sort before some relatively more trusted pairs if there is a known corresponding value for B.

In a preferred embodiment, in addition to the first and second entries, the retrieval information sets fuirther contain check information which allows the grantee to determine that the grantor who asserted this association knew the value of B associated with the value of X in the second entry. Since B values preferably are generated by the grantor for use with grants to a single grantee in a single session, it is unlikely that a malicious entity would know the correct value of B for a value of X actually used for grants to another grantee. This means that if the check information is determined to be valid, it is likely that the first entry does, indeed, contain an encryption, using B, of the decryption key k, and the retrieval information set should be considered very trustworthy. On the other hand, if the check information is determined to be invalid, the retrieval information set should be considered to be untrustworthy and not returned. It is noted that in some cases, a malicious entity might be able to construct valid check information, as when the value of X is one that previously had been used to grant it access to a data object or when the malicious entity itself constructs B. In such cases, the grantee will determine in step 181 that the value of X should not be trusted in the future. In a preferred embodiment, the check information includes H(B;h), a cryptographic hash (not necessarily using the same hash function as used elsewhere herein) of a value including the reference to the data object and B. To verify the check information, the prioritization routine 260 computes the value using the value of B stored in table 251 and the reference to the data object, which is passed in as a parameter. If the result is equivalent to the check information, the check information is considered valid. If there is no associated B, the data access pair preferably is considered to be less trustworthy than data access pairs for which the check information can be verified.

It is noted that in addition to potentially having retrieval information sets with different values of X, there might also exist retrieval information sets having the same value of X. This latter situation can arise, for example, if a malicious party were to learn that a particular value of X is associated with a particular grantee and then store a bogus data access pair based on this information. In such a case (with the presumption that the party is malicious), the corresponding first entry or entries in retrieval information sets added by the malicious party almost certainly will not have a value which will allow the grantee, with the knowledge of the B associated with the duplicated X, to retrieve the correct decryption key k. Therefore, in the absence of check information, which would allow the grantee to distinguish between malicious and non-malicious data access pairs, even though the grantee knows the correct value of B, the particular X should have a low trustworthiness value (although, in some cases, not one low enough to not warrant trying if there are no other choices). Certain techniques described in the “Associations” application can be used to help prevent a malicious entity from learning the value of X in the first place; those techniques generally require an entity to prove it deserves to be trusted as having identity Id, e.g., by submitting additional information evidencing possession of a second credential associated with the intended grantee.

It is noted that step 171 can be performed by a device 14 associated with the user 12, by a device 22 associated with the decryption key store 28, or any combination of the two.

In step 174, which typically is performed by the user's device 14, a determination is made as to whether the second entry (X) in the data access pair 210 (or one of the data access pairs, if more than one) indicates that the decryption key for the data object encryption key (i.e., the symmetric encryption/decryption key B in the present example) previously has been stored. As indicated above, this determination preferably also is based on whether a stored value has a trustworthiness indicator T that is higher than a specified threshold. Accordingly, in the preferred embodiments this determination involves an examination of the output of prioritization routine 260. If the output list 262 is non-empty and includes entries that have not yet been evaluated, then processing preferably proceeds to step 176. On the other hand, if the output list 262 is empty or all of its entries were evaluated in previous iterations, then processing preferably proceeds to step 177.

In step 176, the stored value for B is retrieved (e.g., from output list 262 or table 251). If there remain multiple values in the output list 262 and have not been evaluated yet in this step 176, then in this iteration the most trusted value for B (e.g., based on its corresponding T value) preferably is selected.

On the other hand, if the determination in step 174 was negative, then in step 177 the symmetric decryption key B is retrieved, decrypted and stored. In this regard, as noted above, in different embodiments of the invention X either contains or refers to a storage location (node) that contains B as encrypted using a public key associated with the present grantee, e.g., E_{pub}(B). This value is retrieved and decrypted using the grantee's private key in order to obtain B. If the data access pair contains check information, such information preferably is used to validate the obtained B. If the obtained B is found to be invalid, the data access pair is discarded, the trustworthiness value T for the given X (e.g., in table 252) is, in some embodiments, reduced, and the next remaining data access pair is tried. If there are multiple possibilities, then one can be selected arbitrarily; however, if the trust information T indicates that one or more of the possibilities should not be trusted, then those possibilities preferably either are not selected at all or are only selected after multiple iterations of this step 174 in which all other possibilities have been evaluated.

Also, it is noted that rather than solely including B, in certain embodiments the encrypted value includes other information as well. In one example in which access rights for multiple grantees are saved in the same data storage node, multiple encrypted values are stored, one corresponding to each grantee. Thus, in one embodiment, a single data storage node includes (E₁(B;c),E₂(B;c), . . . ), where Eᵢ is a public-key encryption using the public key associated with grantee i and c is information that can be used to establish the validity of the decryption. The validity information c may be a well-known constant, a hash or checksum of B (potentially along with other information), Id or some other credential associated with grantee i (or a hash or checksum of such information), a secret shared between the grantor and grantee, or any other information that will enable an entity, upon decrypting the value, to be reasonably certain that what was decrypted had been encrypted using the public key that corresponded to the private key used in the decryption and that, therefore, the value of B obtained from the decryption is the one that was intended by the grantor. Still further, in some embodiments, the value of B contains validity-checking information within it, determined at the time B was generated, and so no additional validity information will be needed.

In such embodiments where multiple values are returned, each having been encrypted with verification information, the different values are decrypted by the entity until a validated decryption result is produced, and the corresponding B is then used. In this embodiment, multiple private-key decryptions often will be performed, but a benefit is that access grants for multiple grantees are stored in a single data storage node without making the grantees' identities known to each other.

In an alternate embodiment in which access grants for multiple grantees are stored in a single data storage node, the data storage node includes <<Id₁; E₁(B)>, <Id₂;E₂(B)>, . . . > and a particular entity i directly retrieves the Eᵢ(B) associated with its identity credential Idᵢ. This approach generally ensures that only a single private-key decryption is performed, but also typically allows each grantee to discover the identities of other grantees with respect to the same data object. In addition, if another individual can guess that a grantee has access, that individual also would be able to discover the identities of the other grantees, unless measures are taken to limit access. For example, in one such embodiment a gateway application is executed on backup server 22 to return only the information associated with the requesting grantee. Whether such a situation is a significant concern typically will depend upon the security of the data store 23 and the desirability of protecting the grantees' identities.

It is noted that both steps 176 and 177 return a value for B, albeit in different ways. In step 180 the obtained value for B is used to decrypt the data object encryption/decryption key k, and then k is used to decrypt the data object itself.

In step 181, the decryption is verified. As noted above, k preferably is a hash of the data object's contents, e.g., H(C)=k, where C is the content of the data object. Accordingly, once those contents have been decrypted in step 180, the identical hash can be calculated and compared to the value of k that was obtained in step 180. If those values match, then processing proceeds to step 182. Otherwise, processing proceeds to step 184. It is noted that in alternate embodiments of the invention, this step 181 is omitted.

In step 182, the appropriate information in table 252 is modified to reflect that the obtained B value apparently was correct, in that it resulted in a verified decryption of the corresponding data object. More preferably, the trustworthiness indicator T preferably is increased for the corresponding X,T pair in table 252.

In step 184, conversely, in order to reflect that the obtained B value apparently was incorrect, the trustworthiness indicator T preferably is decreased for the corresponding X,T pair in table 252. Thereafter, processing returns to step 274 to evaluate the next possibility. As indicated above, the entire output list 262 preferably is evaluated in order of trustworthiness of its entries. If all those entries have been evaluated and none is found to produce a verified decryption of the data object, then if there are any other returned data pairs for which a corresponding entry does not exist in table(s) 250 (or, in some embodiments, which was previously designated to have a level of trustworthiness below the specified threshold), then those entries are evaluated consecutively in step 177 until one is found that results in a verified decryption of the data object.

Summarizing, several variations are possible. For instance, in one embodiment described above, once the value is obtained for B, that value is used to decrypt k, which is used to decrypt the data object, and then the contents of the data object are hashed to verify k. In order to provide earlier verification, certain embodiments include information (e.g., a hash of B, either alone or in combination with other data) that can be used to verify whether the obtained B is correct. Thus, e.g., by including H(h;B), either in the data storage node 125 or the secondary storage node 135, it is possible to verify B as soon as it is obtained. In particular, even if a malicious entity has discovered that X is associated with grants to a particular grantee, it is unlikely that such an entity also will have determined the value for the corresponding B.

The foregoing embodiments solve certain problems associated with the distribution of decryption keys by using asymmetric public/private key encryption/decryption, but within a technique in which a single private key decryption can be amortized over a number (e.g., a large number) of access grants. In the particular context of accessing back-up data, it often will be the case that an entity will rarely require access, but when it does, it will need to retrieve a large number of files. Accordingly, in certain embodiments the table(s) 250 of decryption key information are maintained by the entity for just a relatively short period of time that just covers the desired data-restoration process. In such embodiments, e.g., the table(s) 250 automatically are deleted at the termination of the operating system process, after a specified fixed period of time, or after completion of the file restoration operation. In other embodiments, some or all of each of the table(s) 250 are maintained in persistent storage between invocations. For security, in some embodiments the X and T values are retained in persistent storage, but the B values are not.

In addition, by maintaining information regarding the trustworthiness of stored decryption key information, the present invention often can eliminate a great deal of processing to reject bogus or otherwise unreliable access grant entries.

In certain situations, backdoor access grants are desirable. A “backdoor access grant” is a blanket grant of access to another entity (the “backdoor grantee”) to any of a set of objects granted to a first entity. Such a grant might be required by a corporation to allow data recovery in case of accident to an employee or to enable automatic scanning of data, or might be granted to a government entity for law-enforcement purposes. What makes a backdoor grant differ from a normal grant is that it is not necessary to create separate data storage nodes 125 accessible using an access token based on the backdoor grantee's own credentials. Rather, the backdoor gets the data storage node using the original grantee's credentials and, since it does not know the grantee's private key and so cannot decrypt the encrypted B, uses another mechanism to map from the contained X to the associated B.

One approach is to grant backdoor access by adding an association H(Id₂;X)®E₂(B) (and allowing the backdoor grantee to see the value, which could be allowed directly by the store), where Id₂ is an identity credential associated with the backdoor grantee and E₂(×) is an encryption using the public key for which Id₂ has the corresponding private key. Then, the backdoor grantee preferably is allowed to see the data pairs to which another grantee has access (e.g., <B(k),X>). One approach is to simply provide the backdoor grantee with the Id associated with the grantee (but not the private key for the grantee), so that the backdoor grantee can access all of the same retrieval information in the first instance. Another approach, which does not require disclosure of the grantee's Id to the backdoor grantee, is to have the grantee inform the store that the backdoor grantee's identity should be allowed to see a designated subset or all associations that the grantee is allowed to see. In some embodiments, certain backdoor grantees (e.g., ones associated with the owner of the data store or trusted scanning applications) may simply be considered exempt from access control requirements with respect to associations. Once such data pairs are retrieved, the backdoor grantee can look to see if there is a backdoor grant, obtain B, and use it to decrypt k.

This approach has at least two advantages. First, nobody else, including the original grantee, has to be able to find out that the backdoor grant has been made, and second, the backdoor grant can be made after the fact by anybody who knows both X and B. This could be the grantor, if he has left himself a backdoor grant up front or it could be the grantee. For example, a grantee could make files it can see available to an off-line scanner (after delegating visibility rights to the scanner, e.g., as discussed above).

### System Environment.

Generally speaking, except where clearly indicated otherwise, all of the systems, methods and techniques described herein can be practiced with the use of one or more programmable general-purpose computing devices. Such devices typically will include, for example, at least some of the following components interconnected with each other, e.g., via a common bus: one or more central processing units (CPUs); read-only memory (ROM); random access memory (RAM); input/output software and circuitry for interfacing with other devices (e.g., using a hardwired connection, such as a serial port, a parallel port, a USB connection or a firewire connection, or using a wireless protocol, such as Bluetooth or a 802.11 protocol); software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system), which networks, in turn, in many embodiments of the invention, connect to the Internet or to any other networks; a display (such as a cathode ray tube display, a liquid crystal display, an organic light-emitting display, a polymeric light-emitting display or any other thin-film display); other output devices (such as one or more speakers, a headphone set and a printer); one or more input devices (such as a mouse, touchpad, tablet, touch-sensitive display or other pointing device, a keyboard, a keypad, a microphone and a scanner); a mass storage unit (such as a hard disk drive); a real-time clock; a removable storage read/write device (such as for reading from and writing to RAM, a magnetic disk, a magnetic tape, an opto-magnetic disk, an optical disk, or the like); and a modem (e.g., for sending faxes or for connecting to the Internet or to any other computer network via a dial-up connection). In operation, the process steps to implement the above methods and functionality, to the extent performed by such a general-purpose computer, typically initially are stored in mass storage (e.g., the hard disk), are downloaded into RAM and then are executed by the CPU out of RAM. However, in some cases the process steps initially are stored in RAM or ROM.

Suitable devices for use in implementing the present invention may be obtained from various vendors. In the various embodiments, different types of devices are used depending upon the size and complexity of the tasks. Suitable devices include mainframe computers, multiprocessor computers, workstations, personal computers, and even smaller computers such as PDAs, wireless telephones or any other appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented in software, hardware, firmware or any combination of these, with the particular implementation being selected based on known engineering tradeoffs. More specifically, where the functionality described above is implemented in a fixed, predetermined or logical manner, it can be accomplished through programming (e.g., software or firmware), an appropriate arrangement of logic components (hardware) or any combination of the two, as will be readily appreciated by those skilled in the art.

It should be understood that the present invention also relates to machine-readable media on which are stored program instructions for performing the methods and functionality of this invention. Such media include, by way of example, magnetic disks, magnetic tape, optically readable media such as CD ROMs and DVD ROMs, or semiconductor memory such as PCMCIA cards, various types of memory cards, USB memory devices, etc. In each case, the medium may take the form of a portable item such as a miniature disk drive or a small disk, diskette, cassette, cartridge, card, stick etc., or it may take the form of a relatively larger or immobile item such as a hard disk drive, ROM or RAM provided in a computer or other device.

The foregoing description primarily emphasizes electronic computers and devices. However, it should be understood that any other computing or other type of device instead may be used, such as a device utilizing any combination of electronic, optical, biological and chemical processing.

### Additional Considerations.

Where the term “criterion” is used herein, that term is intended to broadly encompass any condition that must be satisfied. For example, a single criterion can include multiple parts with the requirement that all parts must be satisfied, that at least N of the parts must be satisfied, or the like.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method of decryption key management within a computer processing system, comprising:
(a) creating within the computer system an association between an access token and retrieval information, the access token being a specified function of an identifier for a data object, and the retrieval information including (1) a first entry that corresponds to a value generated by encrypting a decryption key for the data object using a symmetric encryption/decryption key, and (2) a second entry that corresponds to a value generated by encrypting the symmetric encryption/decryption key using an asymmetric public key; and
(b) repeating step (a) for a plurality of different data objects, keeping the symmetric encryption/decryption key identical across repetitions.

2. A method according to claim 1, wherein the access token also is a function of at least one of a credential associated with a grantee and an identifier associated with the grantee.

3. A method according to claim 1, wherein access to the retrieval information also requires submission of additional information evidencing possession of a non-public credential associated with a grantee.

4. A method according to claim 1, wherein the retrieval information for each repetition is stored into a data storage node that is part of a single data structure represented as a hash-based directed acyclic graph (HDAG).

5. A method according to claim 4, wherein the different data objects are part of a single hierarchical data structure and the HDAG has a structure of which at least a portion corresponds to at least a portion of said hierarchical data structure.

6. A method according to claim 1, wherein the specified function comprises a cryptographic hash function.

7. A method according to claim 1, further comprising a step of granting backdoor access to a backdoor grantee by associating a second access token with a backdoor encryption of the symmetric encryption/decryption key, wherein the second access token comprises a specified function of a credential associated with the backdoor grantee, and wherein the backdoor encryption is performed using a second asymmetric public key for which the backdoor grantee has access to a corresponding private key.

8. A method according to claim 1, wherein the second entry functions as a second access token that can be used to retrieve a value that includes the symmetric encryption/decryption key as encrypted using the asymmetric public key.

9. A method according to claim 1, wherein step (b) repeats step (a) for a group of data objects for which a particular grantor is giving a grantee access.

10. A method according to claim 1, wherein the decryption key comprises a hash of contents of the data object.

11. A method according to claim 1, further comprising a step of repeating steps (a) and (b) for a group of access grants to different grantees.

12. A method of decryption key management within a computer processing system, comprising:
(a) accessing retrieval information by submitting an access token that is a specified function of an identifier for a data object, the retrieval information including a first entry and a second entry;
(b) determining if a specified criterion has been satisfied, the specified criterion comprising a condition that a stored symmetric encryption/decryption key previously has been associated with the second entry; and
(c) decrypting information corresponding to the first entry using the stored symmetric encryption/decryption key so as to obtain a decryption key for the data object if the specified criterion has been satisfied.

13. A method according to claim 12, further comprising steps, executed upon a determination that the specified criterion has not been satisfied, of:
(d) performing a key-retrieval decryption based on the second entry, using an asymmetric private key, to obtain a symmetric encryption/decryption key; and
(e) decrypting information within the first entry using the symmetric encryption/decryption key so as to obtain the decryption key for the data object.

14. A method according to claim 13, wherein the key-retrieval decryption is performed on a value associated with the second entry.

15. A method according to claim 13, wherein the key-retrieval decryption is performed a plurality of times on a plurality of different values until a validated decryption result is produced.

16. A method according to claim 12, wherein the access token also is a function of at least one of a credential associated with a grantee and an identifier associated with the grantee.

17. A method according to claim 12, wherein the retrieval information includes a plurality of access grant indications, and further comprising a step of selecting one of the access grant indications based on historical information regarding trustworthiness.

18. A method according to claim 12, wherein the retrieval information further includes check information and the specified criterion further comprises a condition pertaining to using the stored symmetric encryption/decryption key to determine validity of the check information.

19. A computer-readable medium storing computer-executable process steps for decryption key management within a computer processing system, said process steps comprising:
(a) creating within the computer system an association between an access token and retrieval information, the access token being a specified function of an identifier for a data object, and the retrieval information including (1) a first entry that corresponds to a value generated by encrypting a decryption key for the data object using a symmetric encryption/decryption key, and (2) a second entry that corresponds to a value generated by encrypting the symmetric encryption/decryption key using an asymmetric public key; and
(b) repeating step (a) for a plurality of different data objects, keeping the symmetric encryption/decryption key identical across repetitions.

20. A method according to claim 19, wherein the access token also is a function of at least one of a credential associated with a grantee and an identifier associated with the grantee.
